(19) United States
(12) Patent Application Publication
(10) Pub. No.: US 2026/0226966 A1
(43) Pub. Date: Aug. 6, 2026

(54) HYPOCYCLOIDAL MECHANISM

(71) Applicant: Pawel WAWRZYNSKI, Falenty Nowe (PL)

(72) Inventor: Pawel WAWRZYNSKI, Falenty Nowe (PL)

(21) Appl. No.: 19/149,818

(22) PCT Filed: Mar. 18, 2024
(86) PCT No.: PCT/PL2024/050019

§ 371 Date: Jul. 21, 2025

(30) Foreign Application Priority Data
Mar. 27, 2023 (PL) P.444216

(51) Int. Cl. F16H 37/12; F01B 9/04

(52) U.S. Cl. CPC F16H 37/126; F01B 9/042

(57) ABSTRACT

The invention concerns a hypocycloidal mechanism comprising: a shaft (4); a large gear (7) rotatable around its centre and coupled to the shaft (4); a small gear (8) parallel to the large gear (7), rotatably mounted on an axle, passing eccentrically through the large gear (7); a cylinder (1) with a piston (2); a connecting rod (3), on one side connected to the piston (2) and on the other side connected rotatably to the small gear (8) so that the rotation of the large gear (7) and the small gear (8) is coupled to the reciprocating motion of the piston (2); at least one bearing-supported stationary part (6) in which the large gear (7) is rotatably mounted. The invention is characterized in that the stationary part (6) is an internally toothed annular part, the small gear (8) being externally toothed and meshed with the internal toothing (6′) of the stationary part (6); the large gear (7) is externally toothed and is rotatably mounted in the stationary part (6) by means of a bearing (6″), so that the toothing (6′) of the stationary part (6) extends over part of its thickness, and the stationary part has also an untoothed surface with the bearing support over a part of its thickness (6″), the large gear (7) has an untoothed surface complementary to the bearing (6″) of the stationary part, the large gear (7) is coupled to the shaft (4) by means of its toothing (7″); the connecting rod (3) has two arms (3a, 3b) which extend at both sides of the gear assembly (7,8), where the first arm (3a) is connected to the small gear (8) at the first pivot point (O) on one side of the gear assembly (7,8), and the second arm (3b) is connected to the small gear (8) at a second pivot point (O') on the other side of the gear assembly (7,8), wherein the orthogonal projection of the first point (O) on the plane of the large gear (7) is at all times equal to the perpendicular projection of the second point (O′) on the same plane of the large gear (7). The invention also concerns an engine and a compressor comprising such a mechanism.

The object of the invention is a hypocycloidal mechanism comprising: a shaft; a large gear revolving around its centre and coupled to the shaft; a small gear parallel to the large gear, rotatably mounted on an axle, passing eccentrically through the large gear; a cylinder with a piston; a connecting rod, on one side connected to the piston and on the other side rotatably connected to the small gear so that the rotation of the large gear and the small gear are coupled to the reciprocating motion of the piston; and at least one bearing-supported stationary part in which the large gear is rotatably mounted.

A hypocycloidal engine is an engine that uses a hypocycloidal mechanism to convert the reciprocating motion to the rotary motion. This mechanism is an alternative to a crankshaft and connecting rod combination used in most modern internal combustion engines. The other components of the hypocycloidal engine remain essentially the same as in the classic piston engine.

The hypocycloidal engine has an important advantage: it is more economical than the classic piston engine with the crankshaft and the connecting rod, as it wastes much less energy on the friction of the piston against the cylinder.

From the state of the art engine designs are known containing a hypocycloidal mechanism. An example is the so-called Wiseman engine (Priyesh Ray, Sangram Redkar. Analysis and simulation of Wiseman hypocycloidal engine. Cogent Engineering, 2014, 1, pp. 1-10.10.1080/23311916.2014.988402. hal-03029156; and Thomas Conner ‘Critical Evaluation of a Hypocycloidal Wiseman Engine; Arizona State University, 2011, Master's thesis).

From the application PL408050A1 a hypocycloidal slider-crank mechanism is known, in a body of which a main drive crankshaft is longitudinally supported. Crank journals are connected via crank beams to eccentric journals of rotatable drums longitudinally supported along the device, and to the crank journals of the synchronising crankshaft also supported longitudinally along the device. The crank beam is a split element consisting of an upper crossbar and a lower crossbar connected to each other by bolts. Split bores of the crankshaft beams house cups around which plastic rings are placed.

From patent no. PL203459B1 a hypocycloidal mechanism is known, in the body of which there is a crankshaft with a crank and a connecting rod as well as a drive shaft equipped with coaxial gears cooperating with gears of rotatable drums bearing-supported in one axis and equipped with eccentric holes. In these holes, in the bearings, cylindrical bushings are set in which two half-cylinders with hemispherical-shaped hollows are placed, in which the spherical ends of the crankshaft are situated.

From application US20100031916A1 a hypocycloidal motor assembly is known, comprising a pinion shaft and an internally toothed gear, the pinion shaft comprising: a pinion shaft body having a longitudinal axis and defining an opening for receiving a drive shaft journal; a cylinder piston journal substantially adjacent to the pinion shaft body and having a longitudinal axis substantially parallel and laterally offset from the longitudinal axis of the pinion shaft body, the cylinder piston journal being adapted to receive the drive shaft journal. The outer surface of the pinion shaft and the teeth of the gear mesh.

However, the existing engine designs based on the cycloidal mechanism have the following disadvantages:
they are heavy,
they are large,
they are all the heavier and larger when they are more than single-cylinder engines.

These disadvantages are due to the asymmetry of such an engine. It comprises two discs, a larger and a smaller one, which revolve around their axes on shafts coming out of them on one side, while on the other side, close to the circumference of these shafts, there are rotatably connected pins. The discs must be massive and large to remain sufficiently rigid in such an asymmetrical arrangement.

The present invention aims at eliminating defects in solutions from the state of the art.

The invention concerns a hypocycloidal mechanism comprising: a shaft; a large gear rotatable around its centre and coupled to the shaft; a small gear parallel to the large gear, rotatably mounted on an axle, passing eccentrically through the large gear; a cylinder with a piston; a connecting rod, on one side connected to the piston and on the other side connected rotatably to the small gear so that the rotation of the large gear and the small gear is coupled to reciprocating motion of the piston; and at least one bearing-supported stationary part in which the large gear is rotatably mounted, characterised in that:
the stationary part is an internally toothed annular part, the small gear being externally toothed and meshed with the internal toothing of the stationary part,
the large gear is externally toothed and is rotatably mounted in the stationary part by means of a bearing support, so that:
the toothing of the stationary part extends over a part of its thickness and the stationary part has also an untoothed surface with the bearing support over a part of its thickness,
the large gear has an untoothed surface complementary to the bearing support of the stationary part,
the large gear is coupled to the shaft by its teeth,
the connecting rod has two arms which extend at both sides of the gear assembly, wherein the first arm is connected to the small gear at the first pivot point on one side of the gear assembly, and the second arm is connected to the small gear at the second pivot point on the other side of the gear assembly, the perpendicular projection of the first point on the plane of the large gear being at all times equal to the perpendicular projection of the second point on the same plane of the large gear.

Advantageously, the circumference of the small gear fits inside the large gear, with its toothing extending on a part of the thickness extending beyond the thickness of the large gear so that it meshes with the inner toothing of the stationary part.

Advantageously, the small gear and the large gear lie in separate parallel planes.

Advantageously, the large gear is coupled to the shaft via a toothed gear, or a pinion shaft mounted on the shaft.

Advantageously, the mechanism has two stationary parts located at both sides of the large gear.

More advantageously, at the opposite side of the large gear, the mechanism has a small second gear mounted on the same axle as the small gear, with the first arm of the connecting rod connected to the small gear at the first pivot point and the second arm of the connecting rod connected to the small gear via the small second gear, at the second pivot point.

Even more advantageously, the small second gear is externally toothed and meshed with the internal toothing of the stationary part.

It is also advantageous that the mechanism has the first counterweight on the large gear and the second counterweight on the small gear.

The object of the invention is also an internal combustion engine comprising at least one such mechanism.

Advantageously, the engine is a hydrocarbon fuel combustion engine.

The object of the invention is also a reciprocating compressor equipped with such a mechanism.

To summarise: the large gear is symmetrical and rotates on a bearing support that is close to the circumference of this gear (it is not seated on the shaft); the small gear is also symmetrical and rotates on an axle that passes through the large gear; the connecting rod is bifurcated, with one arm passing at one side and the other arm at the other side of both gears; the large gear is meshed with the engine shaft on its circumference.

As a result, the whole arrangement does not need to be very ‘solid’ and heavy to be rigid. In addition, in the variant with a small second gear, the system is symmetrical, which further improves its rigidity. Furthermore, a number of systems that are the object of the invention can be connected to the common motor shaft.

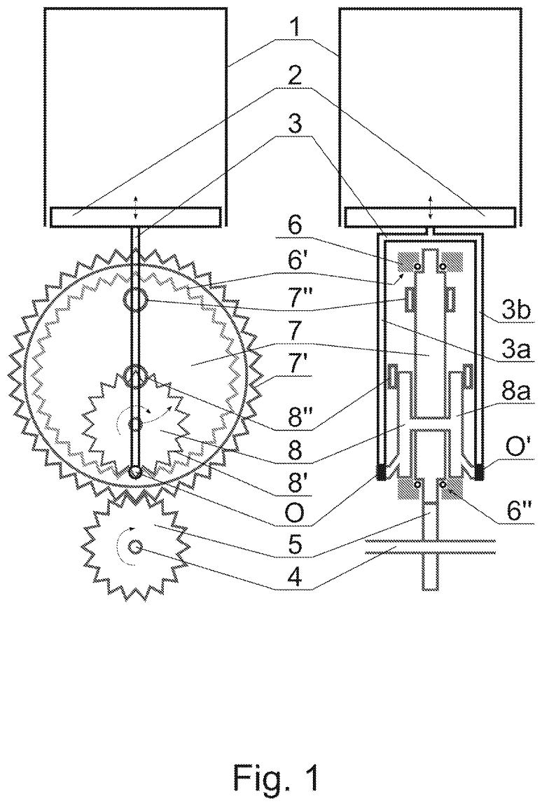

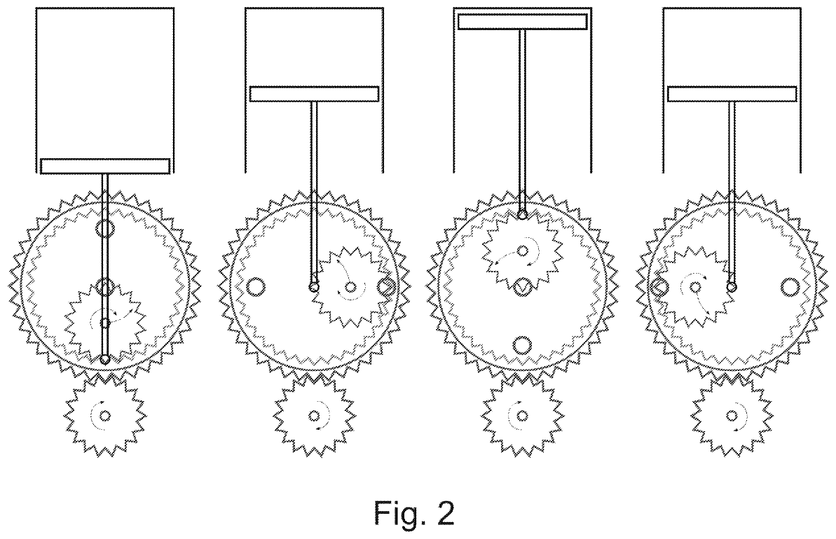

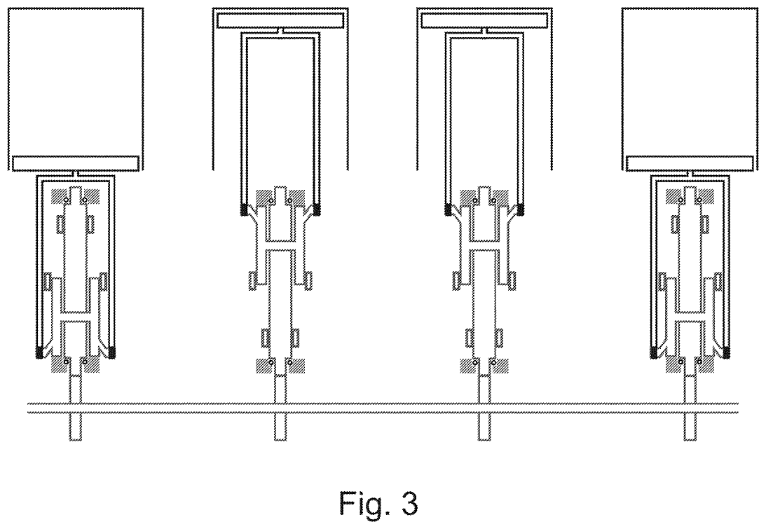

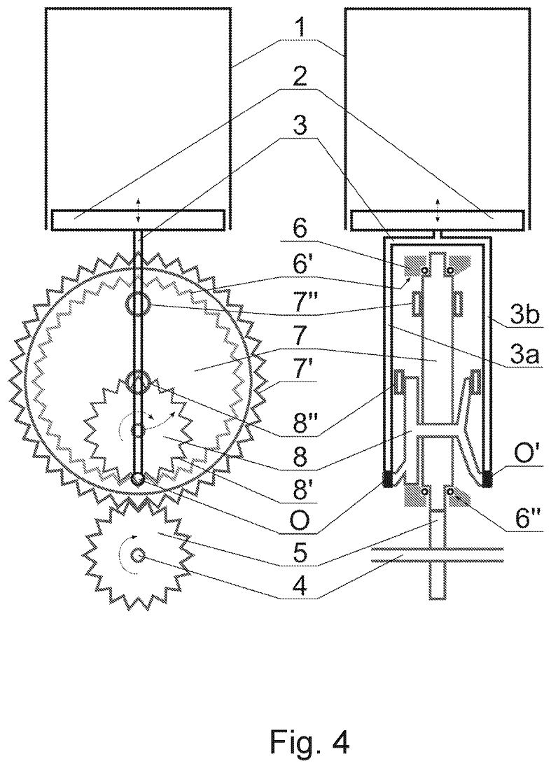

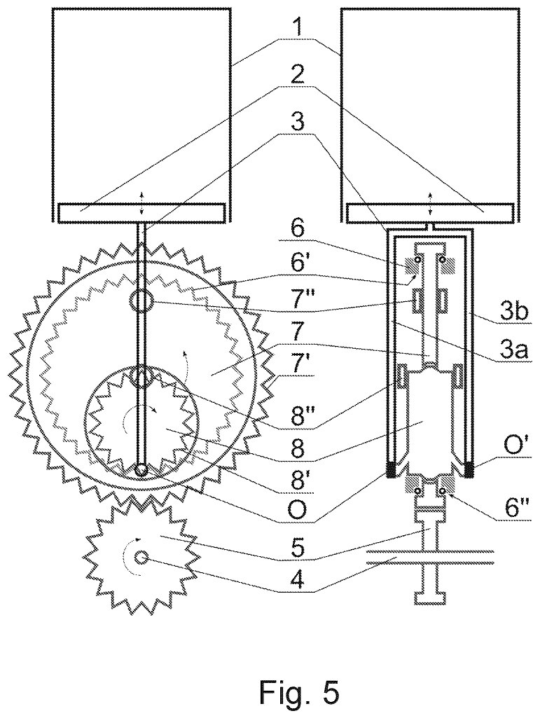

The subject of the invention is depicted in embodiments in the drawing, where FIG. 1 shows a schematic view from two sides of the mechanism according to the invention, FIG. 2 shows a schematic operation of the mechanism according to the invention, FIG. 3 shows a schematic view of a motor equipped with four mechanisms according to the invention, FIG. 4 shows a certain embodiment of the mechanism according to the invention, and FIG. 5 shows another embodiment of the mechanism according to the invention.

As can be seen in the figures, in one embodiment, the hypocycloidal mechanism includes:

A shaft 4,
a large gear 7 rotatable around its centre and coupled to the shaft 4,
a small gear 8 parallel to the large gear 7, rotatably mounted on an axle, passing eccentrically through the large gear 7,
a cylinder 1 with a piston 2,
a connecting rod 3, on one side connected to the piston 2 and, on the other side, rotatably connected to the small gear 8, so that the rotation of the large gear 7 and the small gear 8 is coupled to the reciprocating motion of the piston 2,
at least one bearing-supported stationary part 6, in which the large gear 7 is rotatably mounted.

The stationary part 6 is an internally toothed annular part, with the small gear 8 externally toothed and meshed with the internal toothing 6′ of the stationary part 6,
the large gear 7 is externally toothed and is rotatably seated in the stationary part 6 by means of a bearing support 6″, so that:
the toothing 6′ of the stationary part 6 extends over a part of its thickness and the stationary part has also an untoothed surface with the bearing support 6′ over a part of its thickness,
the large gear 7 has an untoothed surface complementary to the bearing support 6″ of the stationary part,
the large gear 7 is coupled to the shaft 4 by its toothing 7′,
the connecting rod 3 has two arms 3a,3b, which extend at both sides of the gear assembly 7,8, where the first arm 3a is connected to the small gear 8 at the first pivot point O on one side of the gear assembly 7,8, and the second arm is connected to the small gear 8 at the second pivot point O′ on the other side of the gear assembly 7,8, the perpendicular projection of the first point O on the plane of the large gear 7 being at all times equal to the perpendicular projection of the second point O′ on the same plane of the large gear 7.

FIG. 4 shows an embodiment in which the small gear 8 is at one side of the large gear 7. The small gear 8 rotates on an axle passing eccentrically through the large gear 7 and is meshed with the stationary part 6. The small gear 8 is connected to the arm 3a of the connecting rod at the first pivot point O, and also, at the other side of the large gear 7, via the axle of the small gear 8 and an additional connecting element, to the arm 3b of the connecting rod at the second pivot point O′. Furthermore, the small gear 8 has a counterweight 8′, and the connecting element also has a counterweight, respectively.

FIG. 1 shows an advantageous embodiment in which the whole mechanism is symmetrical with respect to the plane of the large gear 7. The small gear 8 located at one side of the large gear 7 corresponds to a symmetrical second small gear 8a at the other side of the large gear 7. The small gears 8 and 8a are meshed with the stationary part 6, they are connected to the connecting rod arms 3a and 3b at the pivot points O and O′, and they are connected to the counterweights 8″. Symmetry with respect to the plane of the gear 7 is an advantageous feature of the mechanism; this feature limits the stresses occurring in the components of the mechanism.

In the embodiment shown in FIG. 5, the mechanism is also symmetrical with respect to the plane of the large gear 7. The circumference of the small gear 8 fits within the interior of the large gear 7, with its toothing 8′ extending on a portion of the thickness projecting beyond the thickness of the large gear 7 so that it meshes with the internal toothing 6′ of the stationary part 6. In such an embodiment, the small gear 8 rolls within the circumference of the large gear 7, and only its projecting toothed part or parts mesh with the toothing 6′ of the stationary part 6.

As can be seen in FIG. 1, FIG. 4 and FIG. 5, in a certain advantageous embodiment, the large gear 7 can be coupled to the shaft 4 via a gear or pinion shaft 5 mounted on the shaft 4.

In an advantageous embodiment, the mechanism has two stationary parts 6 located at both sides of the large gear 7. The figures show a variant with two stationary parts 6, but it is obvious that there can be only one such part, meshed with the small gear 8 and supported for the large gear 7, respectively.

In an equally advantageous embodiment, the mechanism has the first counterweight of 7″ on the large gear 7 and the second counterweight of 8″ on the small gear 8. The counterweights can be seen in the figures in all embodiments, but they are not necessary for the operation of the mechanism.

The principle of the mechanism is shown in FIG. 2 and it is as follows:
the motion of the piston 2 is coupled to the motion of the connecting rod 3,
the motion of connecting rod 3 is coupled to the motion of the first point O on the small gear 8 (the axle connecting this gear to the connecting rod 3),
the motion of the first point O on the small gear 8, when it meshes with the stationary annular part 6 of the motor, translates into the motion of the small gear 8 axle around the large gear 7 axle,
The rotation of large gear 7 is coupled to the rotation of the shaft 4.

FIG. 3 shows an internal combustion engine according to the invention. The engine shown in this figure contains four hypocycloidal mechanisms according to the invention, but it is evident that it can contain any number of them suitable for the application of the engine. The engine may comprise mechanisms in any variant of the embodiments discussed above. In an advantageous embodiment, the engine is a hydrocarbon fuel combustion engine.

The mechanism can also be used in a reciprocating compressor (not shown), which is also a subject of the invention. In such an application, the piston 2 can draw gas at a lower pressure into the cylinder 1 through one cylinder valve and force it at a higher pressure into an external vessel through the second cylinder valve. The compressor may comprise a mechanism in any of the variants of the embodiments discussed above.

Obviously, the invention is not limited to the embodiments described above, and the features indicated in the claims can be combined in any manner appropriate to the particular application of the solution.

1. A hypocycloidal mechanism, containing:
a shaft (4),
a large gear (7) rotatable around its centre and coupled to the shaft (4),
a small gear (8) parallel to the large gear (7), rotatably mounted on an axle, the axle passing eccentrically through the large gear (7),
a cylinder (1) with a piston (2),
a connecting rod (3), on one side connected to the piston (2) and, on the other side,
rotatably connected to the small gear (8) so that the rotation of the large gear (7) and the small gear (8) is coupled to the reciprocating motion of the piston (2),
at least one bearing-supported stationary part (6), in which a large gear (7) is rotatably mounted,
characterised in that:
the stationary part (6) constitutes an internally toothed annular part, the small gear (8) being externally toothed and meshed with the internal toothing (6′) of the stationary part (6),
the large gear (7) is externally toothed and is rotatably seated in the stationary part (6) by means of a bearing (6″), so that:
the toothing (6′) of the stationary part (6) extends over a part of its thickness and the stationary part has also an untoothed surface with the bearing support over a part of its thickness (6″),
the large gear (7) has an untoothed surface complementary to the bearing support (6″) of the stationary part,
the large gear (7) is coupled to the shaft (4) by its toothing (7′),
the connecting rod (3) has two arms (3a,3b) which extend at both sides of the gear assembly (7,8), where the first arm (3a) is connected to the small gear (8) at a first pivot point (O) on one side of the gear assembly (7,8), and the second arm (3b) is connected to the small gear (8) at the second pivot point (O′) on the other side of the gear assembly (7,8), wherein the perpendicular projection of the first point (O) on the plane of the large gear (7) is at all times equal to the perpendicular projection of the second point (O') on the same plane of the large gear (7).

2. A mechanism according to claim 1, characterised in that the circumference of the small gear (8) fits inside the large gear (7), with its toothing (8′) extending on a part of its thickness extending beyond the thickness of the large gear (7) so that it meshes with the inner toothing (6′) of the stationary part (6).

3. A mechanism according to claim 1, characterised in that the small gear (8) and the large gear (7) lie in separate parallel planes.

4. A mechanism according to claim 1, characterised in that the large gear (7) is coupled to the shaft via a toothed gear or a pinion shaft (5) mounted on the shaft (4).

5. A mechanism according to claim 1, characterised in that it has two stationary parts (6) situated at both sides of the large gear (7).

6. A mechanism according to claim 3, characterised in that it has a small second gear (8a) at the opposite side of the large gear (7), which is mounted on the same axle as the small gear (8), the first arm (3a) of the connecting rod (3) being connected to the small gear (8) at the first pivot point (O), and the second arm (3b) of the connecting rod (3) being connected to the small gear (8) via the small second gear (8a) at the second pivot point (O′).

7. A mechanism according to claim 6, characterised in that the second small gear (8a) is externally toothed and meshed with the inner toothing (6′) of the stationary part (6).

8. A mechanism according to claim 1, characterised in that it has a first counterweight (7″) on the large gear (7) and a second counterweight (8″) on the small gear (8).

9. An internal combustion engine, characterised in that it comprises at least one mechanism as defined in claim 1.

10. An internal combustion engine according to claim 9, characterised in that it is a hydrocarbon fuel combustion engine.

11. A reciprocating compressor, characterised in that it comprises a mechanism as defined in claim 1.
